(19) United States
(12) Patent Application Publication
(10) Pub. No.: US 2020/0317905 A1
(43) Pub. Date: Oct. 8, 2020

(54) DISPERSANT COMPOSITION FOR INORGANIC SOLID SUSPENSIONS

(71) Applicant: BASF SE, Ludwigshafen am Rhein (DE)

(72) Inventors: Torben GAEDT, Trostberg (DE); Joachim DENGLER, Trostberg (DE); Oliver MAZANEC, Trostberg (DE)

(73) Assignee: BASF SE, Ludwigshafen am Rhein (DE)

(21) Appl. No.: 16/324,201

(22) PCT Filed: Aug. 4, 2017
(86) PCT No.: PCT/EP2017/069767

§ 371 Date: Feb. 8, 2019

(30) Foreign Application Priority Data
Aug. 11, 2016 (EP) 16183684.6

(51) Int. Cl. C08L 51/08; C08F 216/14; C08F 290/06; C08G 6/02; C04B 40/00

(52) U.S. Cl. CPC C08L 51/08; C08F 216/1458; C08J 3/122; C08G 6/02; C04B 40/0042; C08F 290/062

(57) ABSTRACT

The invention relates to a composition in the form of a solid and suitable as a dispersant for inorganic solids suspensions, comprising A) at least one water-soluble polymer comprising polyether groups, and B) at least one water-soluble condensation product comprising acid groups and/or salts thereof and based on monomers, the monomers comprising at least α) a monomer having a ketone radical and β) formaldehyde. Further disclosed are a method for producing the composition of the invention, and the use thereof in an inorganic binder composition.

The invention relates to a composition in the form of a solid and suitable as a dispersant for inorganic solids suspensions. Further disclosed are a method for producing the composition, and the use thereof in an inorganic binder composition.

In order to endow inorganic solids suspensions with enhanced workability, i.e., kneadability, spreadability, sprayability, pumpability or flowability, they are often admixed with admixtures in the form of dispersants or plasticizers.

In the construction industry, such inorganic solids normally comprise inorganic binders such as, for example, cement based on Portland cement (EN 197), cement with particular properties (DIN 1164), white cement, calcium aluminate cement or high-alumina cement (EN 14647), calcium sulfoaluminate cement, specialty cements, calcium sulfate n-hydrate (n=0 to 2), lime or building-lime (EN 459), and also pozzolans and latent hydraulic binders such as, for example, flyash, metal kaolin, silica dust, and slag sand. The inorganic solids suspensions further generally comprise fillers, more particularly aggregate consisting, for example, of calcium carbonate, quartz or other natural rocks in various grain sizes and grain shapes, and also further inorganic and/or organic additives (admixtures) for the targeted influencing of properties of chemical products used in construction, such as hydration kinetics, rheology or air content, for example. Additionally present may be organic binders such as latex powders, for example.

In order for building material mixtures, based more particularly on inorganic binders, to be converted into a workable, ready-to-use form, the amount of mixing water required is generally substantially more than would be necessary for the subsequent hydration or hardening process. The void fraction in the construction element that is formed by the excess water, which later evaporates, leads to significantly impaired mechanical strength, stability, and durability of adhesion.

In order to reduce this excess water fraction for a specified working consistency and/or to improve the workability in the case of a specified water/binder ratio, admixtures are used which are referred to generally in construction chemistry as water reducers or plasticizers. Known such admixtures include, in particular, polycondensation products based on naphthalenesulfonic or alkylnaphthalenesulfonic acids and/or on melamine-formaldehyde resins comprising sulfonic acid groups.

DE 3530258 describes the use of water-soluble sodium naphthalenesulfonic acid-formaldehyde condensates as admixtures for inorganic binders and building materials. These admixtures are described as improving the flowability of the binders such as cement, anhydrite or gypsum, for example, and also the building materials produced using them.

DE 2948698 describes hydraulic mortars for screeds, comprising plasticizers based on melamine-formaldehyde condensation products and/or sulfonated formaldehyde-naphthalene condensates and/or lignosulfonate and, as binders, Portland cement, clay-containing lime marl, clay clinkers, and soft-fired clinkers.

In addition to the purely anionic plasticizers, which comprise essentially carboxylic acid and sulfonic acid groups, a more recent group of plasticizers described comprises weakly anionic comb polymers, which customarily carry anionic charges on the main chain and comprise nonionic polyalkylene oxide side chains.

WO 01/96007 describes these weakly anionic plasticizers and grinding assistants for aqueous mineral suspensions, prepared by radical polymerization of monomers comprising vinyl groups and comprising polyalkylene oxide groups as a main component.

DE 19513126 and DE 19834173 describe copolymers based on unsaturated dicarboxylic acid derivatives and oxyalkylene glycol alkenyl ethers and the use thereof as admixtures for hydraulic binders, especially cement.

The aim of adding plasticizers in the construction industry is either to increase the plasticity of the binder system or to reduce the amount of water required under given working conditions.

It has emerged that plasticizers based on lignosulfonate, melamine-sulfonate, and polynaphthalenesulfonate are significantly inferior in their activity to the weakly anionic, polyalkylene oxide-containing copolymers. These copolymers are also referred to as polycarboxylate ethers (PCEs). Polycarboxylate ethers not only disperse the inorganic particles via electrostatic charging, owing to the anionic groups (carboxylate groups, sulfonate groups) present on the main chain, but also, furthermore, stabilize the dispersed particles by steric effects owing to the polyalkylene oxide side chains, which absorb molecules of water to form a stabilizing protective layer around the particles.

As a result, either it is possible to reduce the required amount of water for the formulating of a particular consistency, as compared with the conventional plasticizers, or else the addition of the polycarboxylate ethers reduces the plasticity of the wet building-material mixture to such an extent that it is possible to produce self-compacting concrete or self-compacting mortar with low water/cement ratios.

Additionally, the use of the polycarboxylate ethers makes it possible to produce ready-mixed concrete or ready-mixed mortar that remains pumpable for longer periods of time, or to produce high-strength concretes or high-strength mortars by formulation of a low water/cement ratio.

In addition to the polycarboxylate ethers described, a series of derivatives with modified activity profile have now also become known. For example, US 2009312460 describes polycarboxylate esters, where the ester function is hydrolyzed subsequent to introduction into a cementitious, aqueous mixture, to form a polycarboxylate ether. An advantage of polycarboxylate esters is that they develop their activity only after a certain time in the cementitious mixture, and, consequently, the dispersing effect can be maintained over a relatively long period of time.

Dispersants based on polycarboxylate ethers and derivatives thereof are available either as solids in powder form or aqueous solutions. Polycarboxylate ethers in powder form may be admixed, for example, to a factory dry-mix mortar in the course of its production. When the factory dry-mix mortar is mixed with water, the polycarboxylate ethers dissolve and are able subsequently to develop their effect.

DE 199 05 488 discloses polymer compositions in powder form that are based on polyether carboxylates, comprising 5 to 95 wt % of the water-soluble polymer and 5 to 95 wt % of a finely divided mineral carrier material. The products are produced by contacting the mineral carrier material with a melt or an aqueous solution of the polymer. Advantages touted for this product in comparison to spray-dried products include significantly enhanced sticking resistance and caking resistance.

By virtue of their physical properties, many polymeric dispersants are difficult to convert into powder form and are therefore made available in the form of their aqueous solutions. For many applications, such as dry-mix mortars, however, it is vital to provide dispersants in solid form. Generally, therefore, there was a need to provide a dispersant in solid form that do not retard the setting of the inorganic binder.

WO 2013/020862 discloses a method for producing a solid dispersant for a hydraulically setting composition, in which a comb polymer comprising carboxyl groups and at least one second polymer, selected from a condensate of an aromatic compound and formaldehyde or lignosulfonate, are jointly spray-dried in the form of an aqueous composition. A disadvantage of the resulting dispersants, however, is that they retard the setting process of the hydraulically setting compositions.

Spray drying, also called atomization drying, is a process for the drying of solutions, suspensions or pasty masses. Using a nozzle, which in general is operated by the liquid pressure, compressed air or inert gas, or using rotating atomizer discs (4000-50 000 revolutions/min), the material for drying is introduced into a hot air stream, which dries it to a fine powder within a very short time. Depending on the type of construction or the end use, it is possible for the hot air to flow in the same direction as the spray jet, in other words according to the cocurrent principle, or against the spray jet, in order words according to the countercurrent principle. The spraying apparatus is preferably located in the top part of a spraying tower. In this case, the dried material produced is separated from the air stream in particular by means of a cyclone separator, and can be taken off at this point. Also known is the continuous or discontinuous operation of spray dryers.

It was an object of the present invention, accordingly, to provide a dispersant in the form of a solid that has very good powder properties, the intention being that these properties should be retained in particular under thermal and mechanical loading. At the same time, the dispersant ought to avoid the disadvantages of the prior art, particularly the retardation of setting of the inorganic binder, and ought to exhibit improved metering efficiency.

This object has been achieved by means of a composition in the form of a solid and suitable as a dispersant for inorganic solids suspensions, comprising

A) at least one water-soluble polymer comprising polyether groups and
B) at least one water-soluble condensation product which comprises acid groups and/or salts thereof and is based on monomers, the monomers comprising at least α) a monomer having a ketone radical and β) formaldehyde.

Surprisingly it has emerged here not only that the stated object could be achieved to its full extent, but also that the composition of the invention exhibits excellent performance properties not only in hydraulic binder compositions comprising Portland cement, for example, but also in nonhydraulic binder compositions comprising gypsum, for example.

The water-soluble polymers A) of the invention, comprising polyether groups, preferably comprise at least two monomer units. It can, however, also be advantageous to use copolymers having three or more monomer units.

With particular preference the water-soluble polymer A) of the invention comprises at least one group from the series consisting of carboxyester, carboxyl, phosphono, sulfino, sulfo, sulfamido, sulfoxy, sulfoalkyloxy, sulfinoalkyloxy, and phosphonooxy group.

With more particular preference the polymer of the invention comprises an acid group. The term “acid group” in the present specification refers both to the free acid and also salts thereof. The acid may preferably be at least one from the series consisting of carboxyl, phosphono, sulfino, sulfo, sulfamido, sulfoxy, sulfoalkyloxy, sulfinoalkyloxy, and phosphonooxy group. Particularly preferred are carboxyl and phosphonooxy groups. In an embodiment which is also particularly preferred, the water-soluble polymer A) of the invention comprises at least one carboxyester group, which more particularly is a hydroxyalkyl ester. The alkyl group of the hydroxyalkyl esters comprises preferably 1 to 6, preferably 2 to 4, carbon atoms.

“Water-soluble polymers” in the context of the present specification are polymers which in water at 20° C. under atmospheric pressure have a solubility of at least 1 gram per liter, more particularly at least 10 grams per liter, and very preferably at least 100 grams per liter.

In one preferred embodiment, the polyether groups of the at least one water-soluble polymer A) are polyether groups of the structural unit (I),

*—U—(C(O))ₖ—X-(AlkO)ₙ—W (I)

where
* indicates the bonding site to the polymer,
U is a chemical bond or an alkylene group having 1 to 8 carbon atoms,
X is oxygen, sulfur or a group NR¹,
k is 0 or 1,
n is an integer whose average value based on the polymer is in the range from 3 to 300,
Alk is C₂-C₄ alkylene, it being possible for Alk to be identical or different within the group (Alk-O)ₙ,
W is a hydrogen, a C₁-C₆ alkyl or an aryl radical or is the group Y—F, where
Y is a linear or branched alkylene group having 2 to 8 carbon atoms and may carry a phenyl ring,
F is a 5- to 10-membered nitrogen heterocycle which is bonded via nitrogen and which as ring members, besides the nitrogen atom and besides carbon atoms, may have 1, 2 or 3 additional heteroatoms, selected from oxygen, nitrogen, and sulfur, it being possible for the nitrogen ring members to have a group R², and for 1 or 2 carbon ring members to be present in the form of a carbonyl group,
R¹ is hydrogen, C₁-C₄ alkyl or benzyl, and
R² is hydrogen, C₁-C₄ alkyl or benzyl.

It has been proven particularly advantageous with respect to the present invention when structural unit (I) has a value for n of 5 to 135, particularly 10 to 70, and more particularly 15 to 50.

In one particularly preferred embodiment, the water-soluble polymer A) comprising polyether groups represents a polycondensation product comprising
(II) a structural unit comprising an aromatic or heteroaromatic and the polyether group, and
(III) a phosphated structural unit comprising an aromatic or heteroaromatic.

The structural units (II) and (III) are represented preferably by the following general formulae

A-U—(C(O))ₖ—X-(AlkO)ₙ—W (II)

where
A is identical or different and is represented by a substituted or unsubstituted, aromatic or heteroaromatic compound having 5 to 10 carbon atoms in the aromatic system, the other radicals possessing the definition stated for structural unit (I);

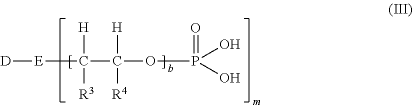

where
D is identical or different and is represented by a substituted or unsubstituted, aromatic or heteroaromatic compound having 5 to 10 carbon atoms in the aromatic system.

Furthermore, E is identical or different and is represented by N, NH or O, m=2 if E=N and m=1 if E=NH or O.

R³ and R⁴ independently of one another are identical or different and are represented by a branched or unbranched C₁ to C₁₀ alkyl radical, C₅ to C₈ cycloalkyl radical, aryl radical, heteroaryl radical or H, preferably by H, methyl, ethyl or phenyl, more preferably by H or methyl, and especially preferably by H. Furthermore, b is identical or different and is represented by an integer from 0 to 300. If b=0, then E=O. More preferably D=phenyl, E=O, R³ and R⁴═H, and b=1.

The polycondensation product preferably comprises a further structural unit (IV), which is represented by the following formula

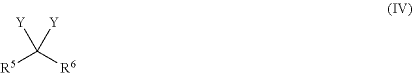

where
Y independently of one another is identical or different and is represented by (II), (III) or further constituents of the polycondensation product.

R⁵ and R⁶ are identical or different and are represented by H, CH₃, COOH, or a substituted or unsubstituted, aromatic or heteroaromatic compound having 5 to 10 carbon atoms. In structural unit (IV) here, R⁵ and R⁶ independently of one another are preferably represented by H, COOH and/or methyl.

In one particularly preferred embodiment, R⁵ and R⁶ are represented by H.

The molar ratio of the structural units (II), (III), and (IV) in the phosphated polycondensation product of the invention may be varied within wide ranges. It has proven useful for the molar ratio of the structural units [(II)+(III)]:(IV) to be 1:0.8 to 3, preferably 1:0.9 to 2, and more preferably 1:0.95 to 1.2.

The molar ratio of the structural units (II):(III) is normally 1:10 to 10:1, preferably 1:7 to 5:1, and more preferably 1:5 to 3:1.

The groups A and Din the structural units (II) and (III) of the polycondensation product are usually represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl and/or 4-methoxynaphthyl, preferably phenyl, and A and D may be selected independently of one another and may also each consist of a mixture of the compounds stated. Groups X and E independently of one another are preferably represented by O.

Preferably, n in structural unit (I) is represented by an integer from 5 to 280, more particularly 10 to 160, and very preferably 12 to 120, and b in structural unit (III) is represented by an integer from 0 to 10, preferably 1 to 7, and more preferably 1 to 5. The respective radicals whose length is defined by n and b, respectively, may consist here of unitary structural groups; however, it may also be useful for them to comprise a mixture of different structural groups. Furthermore, independently of one another, the radicals of the structural units (II) and (III) may each possess the same chain length, with n and b each being represented by one number. In general, however, it will be useful for each of them to comprise mixtures having different chain lengths, so that the radicals of the structural units in the polycondensation product have different numerical values for n and, independently, for b.

In one particular embodiment, the present invention further provides for the salt of the phosphated polycondensation product to be a sodium, potassium, ammonium and/or calcium salt and preferably a sodium and/or potassium salt.

The phosphated polycondensation product of the invention often has a weight-average molecular weight of 5000 g/mol to 150 000 g/mol, preferably 10 000 to 100 000 g/mol, and more preferably 20 000 to 75 000 g/mol.

With regard to the phosphated polycondensation products for preferred use in accordance with the present invention, and to their preparation, reference is further made to patent applications WO 2006/042709 and WO 2010/040612, the content of which is hereby incorporated into the specification.

In a further preferred embodiment, the water-soluble polymer A) comprises at least one copolymer which is obtainable by polymerizing a mixture of monomers comprising
(V) at least one ethylenically unsaturated monomer which comprises at least one radical from the series consisting of carboxylic acid, carboxylic salt, carboxylic ester, carboxylic amide, carboxylic anhydride, and carboxylic imide and
(VI) at least one ethylenically unsaturated monomer comprising the polyether group, the polyether group being represented preferably by the structural unit (I).

The copolymers in accordance with the present invention comprise at least two monomer units. It may, however, also be advantageous to use copolymers having three or more monomer units.

In one preferred embodiment, the ethylenically unsaturated monomer (V) is represented by at least one of the following general formulae from the group consisting of (Va), (Vb), and (Vc):

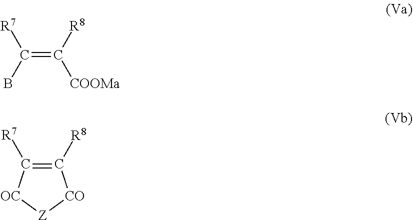

In the monocarboxylic or dicarboxylic acid derivative (Va) and in the monomer (Vb) present in cyclic form, where Z═O (acid anhydride) or NR¹⁶ (acyl imide), R⁷ and R⁸ independently of one another are hydrogen or an aliphatic hydrocarbon radical having 1 to 20 carbon atoms, preferably a methyl group. B is H, —COOMₐ, —CO—O(C_{q}H_{2q}O)ᵣ—R⁹, —CO—NH—(C_{q}H_{2q}O)ᵣ—R⁹.

M is hydrogen, a mono-, di- or trivalent metal cation, preferably sodium, potassium, calcium or magnesium ion, additionally ammonium or an organic amine radical, and a=⅓, ½ or 1, depending on whether M is a mono-, di- or trivalent cation. Organic amine radicals used are preferably substituted ammonium groups deriving from primary, secondary or tertiary C₁₋₂₀ alkylamines, C₁₋₂₀ alkanolamines, C₅₋₈ cycloalkylamines, and C₆₋₁₄ arylamines. Examples of the corresponding amines are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form.

R⁹ is hydrogen, an aliphatic hydrocarbon radical having 1 to 20 carbon atoms, a cycloaliphatic hydrocarbon radical having 5 to 8 carbon atoms, an aryl radical having 6 to 14 carbon atoms, which may optionally also be substituted, q=2, 3 or 4, and r=0 to 200, preferably 1 to 150. The aliphatic hydrocarbons here may be linear or branched and also saturated or unsaturated. Preferred cycloalkyl radicals are cyclopentyl or cyclohexyl radicals, and preferred aryl radicals are phenyl radicals or naphthyl radicals, which in particular may also be substituted by hydroxyl, carboxyl or sulfonic acid groups.

Furthermore, Z is O or NR¹⁶, where R¹⁶ independently at each occurrence is identical or different and is represented by a branched or unbranched C₁ to C₁₀ alkyl radical, C₅ to C₈ cycloalkyl radical, aryl radical, heteroaryl radical or H.

The following formula represents the monomer (Vc):

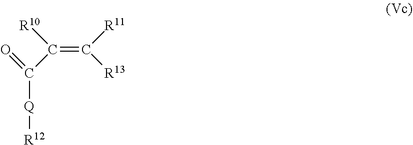

In this formula, R¹⁰ and R¹¹ independently of one another are hydrogen or an aliphatic hydrocarbon radical having 1 to 20 carbon atoms, a cycloaliphatic hydrocarbon radical having 5 to 8 carbon atoms, or an optionally substituted aryl radical having 6 to 14 carbon atoms.

Furthermore, R¹² is identical or different and is represented by (CₙH₂ₙ)—SO₃H where n=0, 1, 2, 3 or 4, (CₙH₂ₙ)—OH where n=0, 1, 2, 3 or 4; (CₙH₂ₙ)—PO₃H₂ where n=0, 1, 2, 3 or 4, (CₙH₂ₙ)—OPO₃H₂ where n=0, 1, 2, 3 or 4, (C₆H₄)—SO₃H, (C₆H₄)—PO₃H₂, (C₆H₄)—OPO₃H₂ and (CₙH₂ₙ)—NR¹⁴b where n=0, 1, 2, 3 or 4 and b is represented by 2 or 3.

R¹³ is H, —COOMₐ, —CO—O(C_{q}H_{2q}O)ᵣ—R⁹, —CO—NH—(C_{q}H_{2q}O)ᵣ—R⁹, where Mₐ, R⁹, q, and r possess the definitions stated above.

R¹⁴ is hydrogen, an aliphatic hydrocarbon radical having 1 to 10 carbon atoms, a cycloaliphatic hydrocarbon radical having 5 to 8 carbon atoms, or an optionally substituted aryl radical having 6 to 14 carbon atoms.

Furthermore, Q is identical or different and is represented by NH, NR¹⁵ or O, and R¹⁵ is an aliphatic hydrocarbon radical having 1 to 10 carbon atoms, a cycloaliphatic hydrocarbon radical having 5 to 8 carbon atoms, or an optionally substituted aryl radical having 6 to 14 carbon atoms.

In one particularly preferred embodiment, the ethylenically unsaturated monomer (VI) is represented by the following general formulae

### (VI)

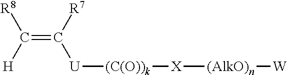

in which all radicals have the definitions stated above.

In particular, the copolymer has an average molar weight (Mw) of between 5000 and 150 000 g/mol, more preferably 10 000 to 80 000 g/mol, and very preferably 15 000 to 60 000 g/mol, as determined by gel permeation chromatography.

The polymers are analyzed by size exclusion chromatography for average molar mass and conversion (column combinations: Shodex OH-Pak SB 804 HQ and OH-Pak SB 802.5 HQ from Showa Denko, Japan; eluent: 80 vol % aqueous solution of HCO₂NH₄ (0.05 mol/l) and 20 vol % MeOH; injection volume 100 μl; flow rate 0.5 ml/min).

The copolymer of the invention preferably meets the requirements of the industry standard EN 934-2 (February 2002).

The composition of the invention further comprises at least one water-soluble condensation product B), comprising acid groups and/or salts thereof and based on monomers, the monomers comprising at least

α) a monomer having a ketone radical and
β) formaldehyde.

With particular preference the acid groups of the condensation product B) comprise at least one from the series consisting of carboxyl, phosphono, sulfino, sulfo, sulfamido, sulfoxy, sulfoalkyloxy, sulfinoalkyloxy, and phosphonooxy group and/or salts thereof, also referred to as structural unit γ).

In one preferred embodiment the condensation product B) has a monomer ratio of the monomers α) to β) of 1:2 to 3. Especially preferably the condensation product B) has a ratio of the monomers α) to β) to structural unit γ) of 1:2 to 3:0.33 to 1.

The monomer having a ketone radical α) in the condensation product B) preferably comprises at least one ketone from the series consisting of methyl ethyl ketone, acetone, diacetone alcohol, ethyl acetoacetate, levulinic acid, methyl vinyl ketone, mesityl oxide, 2,6-dimethyl-2,5-heptadien-4-one, acetophenone, 4-methoxy-acetophenone, 4-acetylbenzenesulfonic acid, diacetyl, acetylacetone, benzoylacetone, and cyclohexanone. Especially preferred are cyclohexanone and acetone.

In one preferred embodiment the composition of the invention comprises 5 to 95 wt %, preferably 25 to 60 wt %, and especially preferably 30 to 50 wt % of A), the at least one water-soluble polymer comprising polyether groups, and 5 to 95 wt %, preferably 40 to 75 wt %, and especially preferably 50 to 70 wt %, of B), the at least one water-soluble condensation product comprising acid groups and/or salts thereof.

The condensation product B) of the invention comprises as monomer a) more particularly cyclohexanone or acetone or a mixture thereof. As monomer 13), formaldehyde in particular is regarded as particularly preferred. With regard to the acid groups of the condensation product B), they may be introduced preferably by sulfite. The condensation product B) of the invention is prepared especially preferably from cyclohexanone, formaldehyde, and sulfite. Mention may also be made of the fact that the condensation product B) of the invention comprises no polyether groups.

In particular, the condensation product B) has an average molar weight (Mw) of between 10 000 and 40 000 g/mol, more particularly between 15 000 and 25 000 g/mol, which is determined by means of size exclusion chromatography, the measurement being carried out in accordance with section 2.3 of the publication “Cement and Concrete Research”, volume 42, issue 1, January 2012, pages 118 to 123 (“Synthesis, working mechanism and effectiveness of a novel cycloaliphatic superplasticizer for concrete”, L. Lei, J. Plank).

With regard to the condensation product B) for use preferably in accordance with the present invention, and to the preparation thereof, reference is made to the patent applications DE 2341923, particularly page 3, last paragraph to page 5, third paragraph and also page 7, example 1 A), the content thereof being hereby incorporated into the present specification.

In particular, with regard to condensation product B) for use preferably in accordance with the present invention, and to preparation thereof, reference is further made to the patent applications EP 0163459, especially page 7, last paragraph to page 9, second paragraph, the content of which is hereby incorporated into the present specification.

In a further embodiment, with regard to the condensation product B) for use preferably in accordance with the present invention, and to its preparation, reference is made to the publication “Cement and Concrete Research”, volume 42, issue 1, January 2012, pages 118 to 123 (“Synthesis, working mechanism and effectiveness of a novel cycloaliphatic superplasticizer for concrete”, L. Lei, J. Plank), especially sections 2.3 to 2.4 and 3.1, the content of which is hereby incorporated into the present specification.

A further subject of the present invention is a method for producing a composition of the invention, which comprises the following steps:
a) providing a water-soluble polymer A),
b) providing a water-soluble condensation product B),
c) preparing an aqueous mixture comprising the at least one water-soluble polymer A) and the water-soluble condensation product B),
d) spray-drying the aqueous mixture to give a solid.

All conventional spraying apparatus is suitable in principle for implementing the method of the invention.

Suitable spraying nozzles are single-fluid nozzles and also multichannel nozzles such as two-fluid nozzles, three-channel nozzles or four-channel nozzles. Such nozzles may also be designed as what are called “ultrasound nozzles”. Nozzles of these kinds are available commercially.

Furthermore, according to the type of nozzle, an atomizing gas may also be supplied. Atomizing gas used may be air or an inert gas such as nitrogen or argon. The gas pressure of the atomizing gas may with preference be up to 1 MPa absolute, preferably 0.12 to 0.5 MPa absolute.

In one preferred embodiment, the aqueous mixture comprising the at least one water-soluble polymer comprising polyether groups and the water-soluble condensation product B) is produced ahead of the spray-drying step d). In this case, preferably, the aqueous mixture used in accordance with the invention is produced by mixing an aqueous solution of the polymer A) with an aqueous solution of the condensation product B).

Also suitable according to a further embodiment are special nozzles in which different liquid phases are mixed within the nozzle body and then atomized. In this case, an aqueous solution or an aqueous suspension comprising the at least one water-soluble polymer comprising polyether groups, also referred to hereinafter as component A), and also an aqueous solution or aqueous suspension comprising the water-soluble condensation product B), also referred to hereinafter as component B), can first be supplied separately to the nozzle and then mixed with one another within the nozzle head.

One embodiment of the invention relates to ultrasonic nozzles. Ultrasonic nozzles may be operated with or without atomizing gas. With ultrasonic nozzles, atomization is produced by the imparting of vibrations to the phase that is to be atomized. Depending on nozzle size and design, the ultrasonic nozzles may be operated with a frequency of 16 to 120 kHz.

The throughput of liquid phase to be sprayed per nozzle is dependent on the nozzle size. The throughput may be 500 g/h to 1000 kg/h of solution or suspension. In the production of commercial quantities, the throughput is preferably in the range from 10 to 1000 kg/h.

If no atomizing gas is used, the liquid pressure may be 0.2 to 40 MPa absolute. If an atomizing gas is used, the liquid may be supplied unpressurized.

Furthermore, the spray-drying apparatus is supplied with a drying gas such as air or one of the aforementioned inert gases. The drying gas may be supplied in cocurrent or in countercurrent to the sprayed liquid, preferably in cocurrent. The entry temperature of the drying gas may be 120 to 300° C., preferably 150 to 230° C., the exit temperature 60 to 135° C.

As already mentioned, the magnitudes of the spraying parameters to be used, such as throughput, gas pressure or nozzle diameter, are critically dependent on the size of the apparatus. The apparatus is available commercially, and appropriate magnitudes are normally recommended by the manufacturer.

In accordance with the invention, the spraying process is preferably operated such that the average droplet size of the sprayed phases is 5 to 2000 μm, preferably 5 to 500 μm, more preferably 5 to 200 μm. The average droplet size may be determined by laser diffraction or high-speed cameras coupled with an image analysis system.

The above details relating to the spraying process may be applied to all preferred and particularly preferred embodiments that are outlined below. Preferred spraying parameters are also preferred in connection with the embodiments below.

In a particular embodiment of the method, the spraying nozzle is a multichannel nozzle.

In an alternative embodiment, the components are sprayed through a multichannel nozzle and are contacted with one another at the exit of the spraying nozzle. The multichannel nozzle may preferably be a three-channel nozzle or else a two-channel nozzle. In the case of the three-channel nozzle, an atomizer gas, more preferably air or nitrogen, is preferably used in one of the three channels, while the other two channels are for component A) and component B), respectively. In the case of a two-channel nozzle, the required atomization of the two components A) and B) is achieved either through the use of ultrasound or through the use of a centrifugal force nozzle.

Preferred is the use of a three-channel nozzle having one channel for the atomizer gas and two channels for components A) and B). The channels for components A) and B) are separate, in the case both of a two-channel nozzle and of a three-channel nozzle, in order to prevent premature mixing of the components.

Components A) and B) are contacted with one another not until the exit of the two channels for components A) and B) of the spraying nozzle. The effect of the atomizer gas is to form fine droplets, particularly in the form of mist, from the components A) and B) contacted with one another.

Preferred, however, is a method wherein the multichannel nozzle possesses two channels, with component A) and component B) being first premixed with one another and then supplied to the two-channel nozzle, the drying gas being introduced via the second channel.

In an additionally preferred embodiment of the invention, the aqueous mixture prior to spray drying comprises 1 to 55 wt %, preferably 5 to 40 wt %, and especially preferably 15 to 25 wt % of the water-soluble polymer comprising polyether groups and 1 to 55 wt %, preferably 5 to 40 wt %, and especially preferably 25 to 35 wt % of the water-soluble condensation product B), and also 20 to 80 wt %, preferably 35 to 75 wt %, of water.

In the context of the present invention, it is preferred if the aqueous mixture in method step c) is produced and preheated before entry into the spray dryer. In an alternative embodiment, components A) and B) as well, independently of one another, may be preheated prior to entry into the spray dryer. The admission temperature of component A) and, independently thereof, of component B), or the admission temperature of the mixture to the spray dryer, may be between 50 and 200° C., preferably between 70 and 130° C. The pulverulent solid obtained may be subsequently sieved to remove agglomerates. In one preferred embodiment, the solid obtained by the method of the invention is obtained in the form of a dry powder which possesses good flowability.

The powder may also, however, be converted into a different solid form by means of pressure, for example. Another possibility is for the powders obtained to be pelletized by the customary methods. Hence the method of the invention also encompasses solid compositions in the form of pellets or granules. The method of the invention therefore preferably provides for the solid obtained after spray drying to be in the form of powder or granules.

The aqueous mixture used in the method of the invention may also comprise further additives. In an alternative embodiment, components A) and B) independently of one another may comprise further additives. These additives may in particular be stabilizers or byproducts from the production process. Furthermore, antioxidants may in particular be admixed as additives.

After introduction into water (50 wt % mixture), the solid obtained by the method of the invention preferably has a pH of between 2 and 9, more preferably between 3.5 and 6.5. In one specific embodiment, it is also possible for the pH of the aqueous mixtures used in accordance with the invention to be adjusted by addition of an acid or a base ahead of spray drying.

The present invention further envisages the use of the dispersant which has been obtained by the method of the invention in an inorganic binder composition.

The inorganic binder preferably comprises at least one from the group consisting of cement based on Portland cement, white cement, calcium aluminate cement, calcium sulfoaluminate cement, calcium sulfate n-hydrate, and latent hydraulic and/or pozzolanic binder.

The binder composition is preferably a dry-mix mortar. As a result of continual effort toward extensive rationalization and also improved product quality, mortars for a very wide variety of different uses within the construction sector are nowadays hardly any longer mixed together from the starting materials on the building site itself. This function is nowadays largely carried out by the construction materials industry in the factory, and the ready-to-use mixtures are provided in the form of what are called factory dry-mix mortars. Finished mixtures which can be made workable on the building site exclusively by addition of water and mixing are referred to, according to DIN 18557, as factory mortars, more particularly as factory dry-mix mortars. Mortar systems of this kind may fulfill any of a very wide variety of physical construction objectives. Depending on the objective that exists, the binder—which may comprise, for example, cement and/or lime and/or calcium sulfate—is admixed with further additives and/or admixtures in order to adapt the factory dry-mix mortar to the specific application.

The factory dry-mix mortar of the invention may in particular comprise masonry mortars, render mortars, mortars for thermal insulation composite systems, renovating renders, jointing mortars, tile adhesives, thin-bed mortars, screed mortars, casting mortars, injection mortars, filling compounds, grouts, or lining mortars (for drinking-water pipes, for example).

Also included are factory mortars which on production on the building site may be provided not only with water but also with further components, especially liquid and/or pulverulent additives, and/or with aggregate (two-component systems).

The binder composition of the invention, comprising at least one inorganic binder, may in particular also comprise a binder mixture as its binder. Understood as such in the present context are mixtures of at least two binders from the group consisting of cement, pozzolanic and/or latent hydraulic binder, white cement, specialty cement, calcium aluminate cement, calcium sulfoaluminate cement, and the various hydrous and anhydrous calcium sulfates. These mixtures may then optionally comprise further additives.

The examples which follow are intended to elucidate the invention in more detail.

### EXAMPLES

Preparation of the Polymers

The acetone resin was prepared in accordance with polymer 6 of WO15039890 (see table 1 on page 13 in conjunction with page 15, protocol C)) The cyclohexanone resin was prepared in accordance with polymer 14 of WO15039890 (see table 1 on page 13 in conjunction with page 15, protocol B))

Polymer A is a copolymer of ethoxylated vinyloxybutanol having a chain length of 23 ethylene oxide units and acrylic acid. The copolymer was prepared as follows: a glass reactor fitted with a number of feed facilities, stirrer, and dropping funnel was charged with 500 ml of water and 359 g of macromonomer 1 (prepared by ethoxylation of vinyloxybutanol with 23 mol of EO), and this initial charge was conditioned to 13° C. Added to this were 0.01 g of iron(II) sulfate heptahydrate and 5.5 g of Brüggolit FF6. After that, 57.9 g of acrylic acid and 5 g of 30% hydrogen peroxide solution were added. The reaction mixture was stirred at 25 to 35° C. for 0.5 h. Thereafter it was neutralized to a pH of 5 using sodium hydroxide solution. The molecular weight determined by GPC is 22 000 g/mol.

Polymer B is a copolymer of hydroxyethyl acrylate and ethoxylated isoprenol having 23 ethylene oxide units (EO). The copolymer was prepared as follows: a glass reactor was fitted with a stirrer mechanism, pH meter, and metering units and was charged with 267 g of water. 330 g of the melted ethoxylated isoprenol were mixed with the water. The temperature was set at 13° C. and the pH at around 7 by addition of 25% sulfuric acid. This mixture was admixed with 4 mg of iron(II) sulfate heptahydrate, 8.25 g of mercaptoethanol, and 3.2 g of hydrogen peroxide. After that a solution of 200 g of water and 136 g of hydroxyethyl acrylate and also 5 g of Brüggolit E01 and 32 g of water were added over a period of 20 minutes. During the reaction the pH was maintained at 7 by addition of 50% NaOH. The reaction mixture was stirred at 20° C. for 40 minutes. The molecular weight determined by GPC is 18 000 g/mol.

Polymer C is a copolymer of methacrylic acid and methyl-polyethylene glycol methacrylate with 23 ethylene oxide units (EO). The polymer was prepared as follows: 330 g of the methacrylate were melted in a 500 ml three-necked flask equipped with a paddle stirrer at 70° C. The amount of methacrylic acid (70.0 g) and 0.1 g of sodium persulfate were added. The reaction mixture was stirred at 80° C. for 5 hours. The resulting polymer was mixed with 500 ml of water and then neutralized to a pH of 7 using 50% aqueous sodium hydroxide solution. The molecular weight of the resulting polymer was 28 000 g/mol.

The auxiliary polymer was prepared in analogy to page 18, synthesis example 1 of WO 03/097721.

The lignosulfonate used was a commercially available Bretax lignosulfonate from Burgos.

The sulfonated melamine-formaldehyde condensation product used was Melment F10 from BASF Construction Solutions GmbH.

The molecular weight was determined by gel permeation chromatography (GPC) with the following method: column combination: Shodex OH-Pak SB 804 HQ and OH-Pak SB 802.5 HQ from Showa Denko, Japan; eluent: 80 vol % aqueous solution of HCO₂NH₄ (0.05 mol/l) and 20 vol % MeOH; injection volume 100 μl; flow rate 0.5 ml/min. The molecular weight was calibrated using standards from PSS Polymer Standard Service, Germany. For the UV detector, poly(styrene-sulfonate) standards were used, and poly(ethylene oxide) standards for the RI detector. The molecular weight was determined using the results of the RI detector.

Spray Drying

An aqueous mixture was prepared from the respective carrier material in accordance with the conditions of table 3. With vigorous stirring, the polymer was added in the form of an aqueous solution.

The mixtures were dried using a GEA Niro Mobile Minor MM-I spray dryer. Drying took place by means of a two-fluid nozzle at the top of the tower. Drying was dried with nitrogen, which was blown in cocurrent with the material for drying, from top to bottom. 80 kg/h of drying gas were used for the drying. The temperature of the drying gas at the tower entry was 220° C. The feed rate of the material for drying was set such that the outgoing temperature of the drying gas at the tower exit was 100° C. The powder discharged from the drying tower with the drying gas was separated from the drying gas by means of a cyclone.

Spray-dryability was assessed as follows:

TABLE 1

| Grading | Description |
|---|---|
| 1 | Fine, dustlike powder in the sample glass beneath the |
| | cyclone; pipelines and cyclone exhibit only dustlike |
| | wetting; possibly, fine powder-like deposits in the |
| | cone of the drying tower |
| 2 | Fine powder (d(90) particle size <500 μm) in the sample |
| | glass beneath the cyclone; only slight deposits in cyclone |
| | and pipelines; possibly, fine powder-like deposits in the |
| | cone of the drying tower |
| 3 | Coarser powder (d(90) particle size >500 μm) in the |
| | sample glass beneath the cyclone, deposits in cyclone |
| | and pipelines; after 10 seconds of mixing of the powder |
| | in a RETSCH Grindomix GM 200 at 8000 revolutions/min, |
| | a sample is obtained with particle sizes d(99) <500 μm. |
| 4 | Possibly a few larger lumps in the sample glass beneath |
| | the cyclone, sample very largely in the dryer tower, |
| | severe encrustation in pipelines; 10 seconds of mixing |
| | in the RETSCH Grindomix GM 200 at 8000 revolutions/min |
| | sample produce a sample with particle sizes d(80) <500 μm |
| 5 | Empty, possibly waxily wetted sample glass beneath the |
| | cyclone, sample very largely in the form of waxlike |
| | coating in dryer tower and pipelines |

The particle size was determined using a Mastersizer 2000 from Malvern Instruments. It represents the volumetric particle diameter.

The thermomechanical properties of the powder were tested as follows: All of the metal parts required were heated in a drying cabinet at 80° C. before use. A brass tube with a length of 70 mm and an internal diameter of 50 mm for a wall thickness of 2.5 mm were placed onto a brass baseplate with a tube attachment 7 mm high and 55 mm internal diameter. 2 g of powder were introduced into the pipe, followed by a brass cylinder having a weight of 1558 g. This cylinder was rotated by 360° 10 times without pressure. The cylinder and the pipe were then removed, and the sample was classed on the basis of the following factors:

TABLE 2
Powders produced were as follows:

| Grading | Description |
|---|---|
| 1 | Sample is still in powder form |
| 2 | Sample is a compacted powder, and can be broken apart by |
| | the finger or the spatula without application of force |
| 3 | Sample undergoes compaction, force required in order |
| | to disintegrate the sample, possibly slightly tacky |
| 4 | Sample is of waxlike form; initially there are soft |
| | lumps, after cooling there are hard lumps |

TABLE 3

| | | | Mass | Carrier [% of | | Mass | Assessment | Assessment |
|---|---|---|---|---|---|---|---|---|
| Powder | Polymer | Solids | (grams) | total weight] | Solids | (grams) | A | B |
| 1 | A | 40.5 | 123.5 | Cyclohexanone | 41.1 | 365.0 | 2 | 2 |
| | | | | resin [75%] | | | | |
| 2 | A | 40.5 | 246.9 | Cyclohexanone | 41.1 | 243.3 | 2 | 2 |
| | | | | resin [50%] | | | | |
| 3 | A | 40.5 | 370.4 | Cyclohexanone | 41.1 | 121.7 | 2 | 2 |
| | | | | resin [25%] | | | | |
| 4 | B | 52 | 153.8 | Cyclohexanone | 41.1 | 292.0 | 2 | 2 |
| | | | | resin [60%] | | | | |
| 5 | B | 52 | 153.8 | Acetone resin | 41.6 | 288.5 | 2 | 2 |
| | | | | [60%] | | | | |
| 6 | C | 39.2 | 306.1 | Cyclohexanone | 41.1 | 194.6 | 2 | 2 |
| | | | | resin [40%] | | | | |
| 7 | A | 40.5 | 216.6 | Acetone resin | 41.6 | 136 | 2 | 2 |
| | | | | [40%] | | | | |
| C1 | A | | | | | | 2 | 4 |
| C2 | A | 40.5 | 246.9 | Auxiliary | 36.3 | 275.5 | 1-2 | 1-2 |
| | | | | polymer [50%] | | | | |
| C3 | A | 40.5 | 246.9 | Lignosulfonate | 45.5 | 219.8 | 2 | 2 |
| | | | | [50%] | | | | |
| C4 | | | | Cyclohexanone | | | 2 | 2 |
| | | | | resin | | | | |
| C5 | | | | Acetone resin | | | 2 | |
| C6 | B | | | | | | Not dryable | |
| C7 | C | | | | | | 2 | 3-4 |
| C8 | C | 39.2 | 306.1 | Sulfonated | 39.1 | 204.6 | 2 | 2 |
| | | | | melamine- | | | | |
| | | | | formaldehyde | | | | |
| | | | | condensation | | | | |
| | | | | product [40%] | | | | |

Solids = Solids content of the aqueous mixture
Assessment A: Spray-dryability
Assessment B: After thermal/mechanical loading

The dispersant properties were determined with a mortar test.

The cement mortar was composed of 40.0 wt % of Portland cement (CEM I 52.5 N, Milke) and 60.0 wt % of standard sand (DIN EN 196-1). The water/cement ratio (the weight ratio of water to cement) was 0.35. To plasticize the cement mortar, a polymer powder according to table 3 was added. The amount of the polymer powder is shown in table 4 and is based on the amount of cement.

The cement mortar was produced in a method based on DIN EN 196-1:2005 in a mortar mixer having a capacity of approximately 5 liters. For the mixing procedure, water, polymer powder, 0.45 g of the pulverulent defoamer Vinapor DF 9010 F (available from BASF Construction Solutions GmbH) and cement were placed into the mixing vessel. Immediately thereafter the mixing operation was commenced, with the fluidizer at low speed (140 revolutions per minute (rpm)). After 30 seconds, the standard sand was added at a uniform rate within 30 seconds to the mixture.

The mixture was then switched to a higher speed (285 rpm) and mixing was continued for 30 seconds more. The mixer was subsequently halted for 90 seconds. During the first 30 seconds, the cement mortar, which stuck to the wall and to the lower part of the bowl, was removed using a rubber scraper and was put into the middle of the bowl. After the break, the cement mortar was mixed at the higher mixing speed for a further 60 seconds. The total mixing time was 4 minutes.

Immediately after the end of the mixing operation, the slump flow was determined on all samples, using a Hägermann cone, with no compaction energy being supplied, in a method based on the SVB guidelines of the Deutscher Ausschuss für Stahlbeton (German Reinforced Concrete Committee; see: Deutscher Ausschuss für Stahlbetonbau (ed.): DAfStb—Guidelines for self-compacting concrete (SVB Guidelines), Berlin, 2003). The Hägermann cone (d top=70 mm, d bottom=100 mm, h=60 mm) was placed centrally on a dry glass plate having a diameter of 400 mm and was filled with cement mortar to the level intended. Immediately after leveling had taken place, or 5 minutes after the first contact between cement and water, the Hägermann cone was taken off, held over the slumping cement mortar for 30 seconds to allow for dripping, and then removed. As soon as the slump flow came to a standstill, the diameter was determined, using a caliper gauge, at two axes lying at right angles to one another, and the average was calculated. The slump flow profile over time was characterized by repeating the slump flow test after 10, 20, 30, 45, 60, 90, and 120 minutes. Prior to each test, the cement mortar was mixed up in a mortar mixer at a rate of 140 revolutions per minute (rpm) for 10 seconds.

The solidification times were determined to DIN EN 196, part 3.

The results of these tests are set out in table 4.

TABLE 4

| | | Slump flow/cm | | | | | Vicat | |
|---|---|---|---|---|---|---|---|---|
| | Metering | 5 | 10 | 30 | 60 | 120 | solidification | ES/ |
| Powder | % bwoc | min | min | min | min | min | BS/min | min |
| 1 | 0.45 | 28.4 | 26.6 | 23.8 | 21.3 | | 345 | 436 |
| 2 | 0.32 | 30.4 | 27.4 | 23.2 | 22.2 | 19.5 | 419 | 474 |
| 3 | 0.24 | 29.7 | 28.0 | 26.5 | 25.3 | 23.1 | 432 | 505 |
| 4 | 0.5 | 10.0 | 10.0 | 20.8 | 28.3 | | 372 | 418 |
| 5 | 0.6 | 10 | 10 | 20.2 | 24.8 | | 385 | 456 |
| 6 | 0.3 | 26.2 | 23.8 | 21.9 | 21.8 | | 403 | 496 |
| 7 | 0.3 | 29.8 | 28.7 | 27.0 | 24.8 | | 445 | 506 |
| C1 | 0.18 | 30.4 | 29.5 | 27.5 | 26.8 | | 394 | 466 |
| C2 | 0.3 | 28.6 | 27.8 | 26.4 | 24.9 | | 654 | 699 |
| C3 | 0.38 | 28 | 23.4 | 20.8 | 19.3 | | 507 | 544 |
| C4 | 0.7 | Not | | | | | | |
| | | flowable | | | | | | |
| C5 | 0.6 | Not | | | | | | |
| | | flowable | | | | | | |
| C7 | 0.17 | 26.8 | 24.6 | 23.3 | 23.1 | | 366 | 458 |
| C8 | 0.45 | 27.6 | 27.7 | 27.5 | 27.3 | | 398 | 543 |

BS: Beginning of solidification
ES: End of solidification

As can be seen from the experiments, only the powders 1 to 7 of the invention have not only good powder properties but also at the same time good dispersing properties in mortars and permit a low mortar solidification time.

Powder C8 was produced in analogy to the disclosure in WO 2013/020862 and is directly comparable with powder 6 of the invention. In this case it is found that in comparison to powder C8, powder 6 of the invention causes much less retardation of the setting of the inorganic binder and, furthermore, exhibits much better metering efficiency.

1. A composition, in the form of a solid and suitable as a dispersant for inorganic solids suspensions, the composition comprising
A) at least one water-soluble polymer comprising a polyether group and
B) at least one water-soluble condensation product which comprises an acid group and/or a salt thereof and is based on monomers, the monomers comprising
α) a monomer having a ketone radical and
β) formaldehyde.

2. The composition of claim 1, wherein the polyether group of the at least one water-soluble polymer A) is comprised by a structural unit (I) which is represented by the following formula,
*—U—(C(O))ₖ—X-(AlkO)ₙ—W (I)
wherein * indicates the bonding site to the at least one water-soluble polymer A),
U is a chemical bond or an alkylene group having 1 to 8 carbon atoms,
X is oxygen, sulfur, or NR¹, wherein R¹ is hydrogen, a C₁-C₄ alkyl group, or a benzyl group,
k is 0 or 1,
n is an integer whose average value based on the at least one water-soluble polymer A) is in a range of from 3 to 300, and
each Alk is independently a C₂-C₄ alkylene group,
W is hydrogen, a C₁-C₆ alkyl group, or an aryl radical or is a group represented by Y—F,
wherein Y is a linear or branched alkylene group having 2 to 8 carbon atoms and may comprise a phenyl ring, and
F is a 5- to 10-membered nitrogen heterocycle which is bonded via nitrogen and which may have 1, 2, or 3 heteroatoms as ring members in addition to the nitrogen, wherein the heteroatoms are selected from the group consisting of oxygen, nitrogen, and sulfur, it being possible for 1 or 2 carbon ring members to be present in the form of a carbonyl group, and for the nitrogen ring members to have a group R², wherein R² is hydrogen, a C₁-C₄ alkyl group or a benzyl group.

3. The composition of claim 1, wherein the at least one water-soluble polymer A) further comprises at least one selected from the group consisting of a carboxyester group, a carboxyl group, a phosphono group, a sulfino group, a sulfo group, a sulfamido group, a sulfoxy group, a sulfoalkyloxy group, a sulfinoalkyloxy group, and a phosphonooxy group.

4. The composition of claim 1, wherein the at least one water-soluble polymer A) is a polycondensation product comprising
(II) a structural unit comprising an aromatic or heteroaromatic group and the polyether group, and
(III) a phosphated structural unit comprising an aromatic or heteroaromatic group.

5. The composition of claim 4, wherein the structural units (II) and (III) are represented by the following general formulae
A-U—(C(O))ₖ—X-(AlkO)ₙ—W (II)
wherein each A is independently a substituted or unsubstituted, aromatic or heteroaromatic compound having 5 to 10 carbon atoms in the aromatic or heteroaromatic system, and the other radicals are defined as in structural unit (I); and 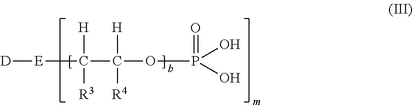
wherein each D is independently a substituted or unsubstituted, aromatic or heteroaromatic compound having 5 to 10 carbon atoms in the aromatic or heteroaromatic system,
each E is independently N, NH or O,
m=2 if E=N and m=1 if E=NH or O,
each R³ and each R⁴ is independently a branched or unbranched C₁ to C₁₀ alkyl radical, C₅ to C₈ cycloalkyl radical, aryl radical, or heteroaryl radical or H, and
each b is independently an integer from 0 to 300.

6. The composition of claim 4, wherein the polycondensation product further comprises a structural unit (IV) which is represented by the following formula 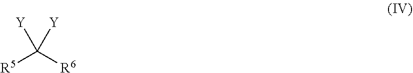
wherein each Y is independently the structural unit (II), the structural unit (III) or a further constituent of the polycondensation product, and
each R⁵ and each R⁶ is independently H, CH₃, COOH, or a substituted or unsubstituted, aromatic or heteroaromatic compound having 5 to 10 carbon atoms.

7. The composition of claim 1, wherein the at least one water-soluble polymer A) comprises at least one copolymer which is obtainable by polymerizing a monomer mixture comprising
(V) at least one ethylenically unsaturated monomer comprising at least one radical selected from the group consisting of a carboxylic acid, a carboxylic salt, a carboxylic ester, a carboxylic amide, a carboxylic anhydride, and a carboxylic imide, and
(VI) at least one ethylenically unsaturated monomer comprising the polyether group.

8. The composition of claim 7, wherein the ethylenically unsaturated monomer (V) is represented by at least one of the following general formulae (Va), (Vb), and (Vc) 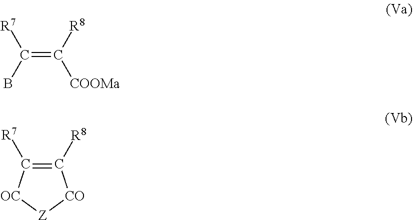
wherein each R⁷ and each R⁸ is independently hydrogen or an aliphatic hydrocarbon radical having 1 to 20 carbon atoms,
B is H, —COOMₐ, —CO—O(C_{q}H_{2q}O)ᵣ—R⁹, or —CO—NH—(C_{q}H_{2q}O)ᵣ—R⁹,
M is hydrogen, a mono-, di- or trivalent metal cation, an ammonium ion, or an organic amine radical,
a is ⅓, ½, or 1,
R⁹ is hydrogen, an aliphatic hydrocarbon radical having 1 to 20 carbon atoms, a cycloaliphatic hydrocarbon radical having 5 to 8 carbon atoms, or an optionally substituted aryl radical having 6 to 14 carbon atoms,
each q is independently 2, 3, or 4,
r is 0 to 200
Z is O, or NR¹⁶, and
each R¹⁶ is independently hydrogen or a branched or unbranched C₁ to C₁₀ alkyl radical, C₅ to C₈ cycloalkyl radical, aryl radical, or heteroaryl radical, 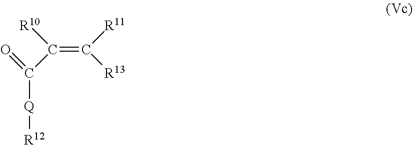
wherein each R¹⁰ and each R¹¹ is independently hydrogen, an aliphatic hydrocarbon radical having 1 to 20 carbon atoms, a cycloaliphatic hydrocarbon radical having 5 to 8 carbon atoms, or an optionally substituted aryl radical having 6 to 14 carbon atoms,
each R¹² is independently (CₙH₂ₙ)—SO₃H where n=0, 1, 2, 3 or 4, (CₙH₂ₙ)—OH where n=0, 1, 2, 3 or 4 (CₙH₂ₙ)—PO₃H₂ where n=0, 1, 2, 3 or 4, (CₙH₂O—OPO₃H₂ where n=0, 1, 2, 3 or 4, (C₆H₄)—SO₃H, (C₆H₄)—PO₃H₂, (C₆H₄)—OPO₃H₂, or (CₙH₂ₙ)—NR¹⁴_{b} where n=0, 1, 2, 3 or 4 and b=2 or 3,
R¹³ is H, —COOMₐ, —CO—O(C_{q}H_{2q}O)ᵣ—R⁹, or —CO—NH—(C_{q}H_{2q}O)ᵣ—R⁹, wherein Mₐ, R⁹, q, and r are defined as in formulae (Va) and (Vb),
R¹⁴ is hydrogen, an aliphatic hydrocarbon radical having 1 to 10 carbon atoms, a cycloaliphatic hydrocarbon radical having 5 to 8 carbon atoms, or an optionally substituted aryl radical having 6 to 14 carbon atoms, and
each Q is independently NH, NR¹⁵, or O; where R¹⁵ is an aliphatic hydrocarbon radical having 1 to 10 carbon atoms, a cycloaliphatic hydrocarbon radical having 5 to 8 carbon atoms, or an optionally substituted aryl radical having 6 to 14 carbon atoms.

9. The composition of claim 1, wherein the acid group of the at least one water-soluble condensation product B) comprises at least one selected from the group consisting of a carboxyl group, a phosphono group, a sulfino group, a sulfo group, a sulfamido group, a sulfoxy group, a sulfoalkyloxy group, a sulfinoalkyloxy group, and a phosphonooxy group and/or a salt thereof.

10. The composition of claim 1, wherein the at least one water-soluble condensation product B) has a monomer ratio of the monomers α) to β) of 1:2 to 3.

11. The composition of claim 1, wherein the monomer having the ketone radical α) in the at least one water-soluble condensation product B) comprises at least one ketone selected from the group consisting of methyl ethyl ketone, acetone, diacetone alcohol, ethyl acetoacetate, levulinic acid, methyl vinyl ketone, mesityl oxide, 2,6-dimethyl-2,5-heptadien-4-one, acetophenone, 4-methoxyacetophenone, 4-acetylbenzenesulfonic acid, diacetyl, acetylacetone, benzoylacetone, and cyclohexanone.

12. The composition of claim 1, which is in the form of powder or granules.

13. The composition of claim 1, which comprises
5 to 95 wt % of the at least one water-soluble polymer A), and
5 to 95 wt % of the at least one water-soluble condensation product B).

14. A method for producing the composition of claim 1, the method comprising:
a) providing at least one water-soluble polymer A),
b) providing at least one water-soluble condensation product B),
c) preparing an aqueous mixture comprising the at least one water-soluble polymer A) and the at least one water-soluble condensation product B), and
d) spray-drying the aqueous mixture to obtain a solid.

15. An inorganic binder composition, comprising the composition of claim 1.
